(19) United States
(12) Patent Application Publication
(10) Pub. No.: US 2006/0285008 A1
(43) Pub. Date: Dec. 21, 2006

(54) Image pickup apparatus and image pickup method

(75) Inventors: Eigo Segawa, Kawasaki (JP); Morito Shiohara, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/211,715

(22) Filed: Aug. 26, 2005

(30) Foreign Application Priority Data
Jun. 20, 2005 (JP) 2005-178905

(51) Int. Cl. H04N 5/222

(52) U.S. Cl. 348/370

(57) ABSTRACT

An image pickup apparatus and an image pickup method allow the viewer to recognize the colors and the reflection characteristics of the picked up image and makes the picked up image satisfactory for monitoring purposes. Visible light is emitted to illuminate a shooting range and, when picking up an image of the range, visible light is made to flicker at a predetermined intensity of light and a frequency higher than a predetermined frequency level in order to pick up an image of the range illuminated by visible light.

### BACKGROUND OF THE INVENTION

1. Field of the Invention

This invention relates to an image pickup apparatus and an image pickup method for picking up an image to be monitored or recognized by a person or a computer.

2. Description of the Related Art

When an image is monitored visually by a person or automatically by a computer, it has to be picked up at a level of lightness that allows the person or the computer to recognize what are in the picked up image. Therefore, when the shooting range of the image pickup apparatus is not sufficiently light as in the case of a shooting operation that is conducted at night, illumination is generally used for the image pickup operation. Illumination in a wavelength band of infrared rays is typically used to avoid the use of a wavelength band of visible light (a wavelength band between about 380 and 780 nm) that dazzles the person or persons in and near the shooting range (see, inter alia, Patent Document 1: Japanese Patent Application Laid-Open Publication No. 9-68742).

For example, in an operation of observing the traffic or recognizing the car numbers on a road at night, the illumination that is used for picking up an image of the road should not dazzle the drivers of the cars that are running on the road. Therefore, rays out of the wavelength band of visible light (e.g., near-infrared rays) are generally used for illumination with a camera that is sensitive to the wavelength band of the illumination in the image pickup operation.

However, when rays out of the wavelength band of visible light such as near-infrared rays are used for illumination in an image pickup operation, the picked up image shows only differences in the intensity of the rays that are used for the illumination. In other words, it is not possible to recognize the colors of the objects in the image. Additionally, the shading of an image that is picked up in rays of illumination that are out of the wavelength band of visible light shows reflection characteristics relative to the wavelength band of the rays of illumination that are different from the reflection characteristics thereof relative to visible light and hence the image may appear strange. Thus, the images picked up by image pickup apparatus of the type under consideration in rays out of the wavelength band of visible light are recognized differently if compared with the corresponding images picked up in rays of visible light. Such images are not satisfactory when they are used for monitoring purposes.

### SUMMARY OF THE INVENTION

In view of the above-identified problem, it is therefore the object of the present invention to provide an image pickup apparatus and an image pickup method that allow the viewer to recognize the colors and the reflection characteristics of the picked up image and make the picked up image satisfactory for monitoring purposes.

In an aspect of the present invention, the above object of the invention is achieved by providing an image pickup apparatus for shooting an illuminated range, the apparatus comprising: a light emitting section that emits visible light to illuminate a shooting range; a light emission control section that drives the light emitting section to flicker at a predetermined intensity of light and a frequency higher than a predetermined frequency level; and an image pickup section that shoots the range illuminated by the light emitting section.

Preferably, in an image pickup apparatus according to the invention, the predetermined frequency is the critical fusion frequency.

Preferably, in an image pickup apparatus according to the invention, the time-averaged intensity of light of Ton·lo/T is not higher than a predetermined intensity level, where Ton is the lighting on time of a flickering cycle of the light emitting section, Toff is the lighting off time of a flickering cycle of the light emitting section, T is the lighting interval and lo is the intensity of emitted light.

Preferably, an image pickup apparatus according to the invention further comprises: an exposure control section that exposes the image pickup section to light in synchronism with the light emitting time set by the light emission control section.

The light emitting section may emit white light or light of the three primary colors.

In another aspect of the present invention, there is provided an image pickup method for illuminating a shooting range and shooting the range, the method comprising: emitting visible light so as to flicker at a predetermined intensity of light and a frequency higher than a predetermined frequency level; and shooting the range illuminated by the visible light.

Thus, according to the invention as defined above, there are provided an image pickup apparatus and an image pickup method that allow the viewer to recognize the colors and the reflection characteristics of the picked up image and makes the picked up image satisfactory for monitoring purposes.

### BRIEF DESCRIPTION OF THE DRAWINGS

FIG. 1 is a schematic block diagram of the first embodiment of the invention;

FIG. 2 is a flickering timing chart of illumination using a rectangular wave;

FIG. 3 is a flickering timing chart of illumination using a trapezoidal wave;

FIG. 4 is a flickering timing chart of illumination using a sinusoidal wave;

FIG. 5 is a schematic block diagram of the second embodiment of the invention; and

FIG. 6 is a timing chart of the operation of the second embodiment.

### DETAILED DESCRIPTION OF THE PREFERRED EMBODIMENTS

Now, the present invention will be described by referring to the accompanying drawings that illustrate preferred embodiments of the invention.

The embodiments of the invention utilize a characteristic feature of the eyes of human being that is known by the rule of Talbot-Plateau. The characteristic feature is that man senses flickering light that flickers at a frequency higher than a given frequency (critical fusion frequency) as sustained light of an intensity value equal to the time-average of the intensities of the flickering light.

It is known as a finding of psychophysics that the critical fusion frequency does not exceed 60 Hz although it changes as a function of the intensity of light and the angle from the center of the eyes of the viewer. Therefore, it is possible to realize illumination of flickering visible light with a sufficient degree of brightness that man does not notice flickering if the light is made to flicker at a frequency not lower than 60 Hz and the lighting on time is made sufficiently short (e.g., a ten thousandth) relative to the lighting off time, while light is irradiated at a high intensity level during the lighting on time. For the purpose of the present invention, the expression of “flickering” refers to light that is made light and dark cyclically and includes “flashing”.

It is possible to pick up a light image by raising the intensity of light sufficiently high relative to the sensitivity of the camera during lighting on time. It is also possible to pickup a lighter image practically without being influenced by external light by selecting an appropriate exposure time and an appropriate gain for the camera and making the camera operate in synchronism with the lighting on time.

In other words, a lighting apparatus that is to be used with the embodiments of the present invention and a specific lighting method is adapted to emit flickering light in a visible range at a flickering frequency that is so high that man do not recognize the flickering and a time average of intensities of flickering light it emits that is lower than such a level that man is not dazzled by the flickering light, while raising the intensity of light during the exposure time of the camera to such a level that the camera can sense colors.

### First Embodiment

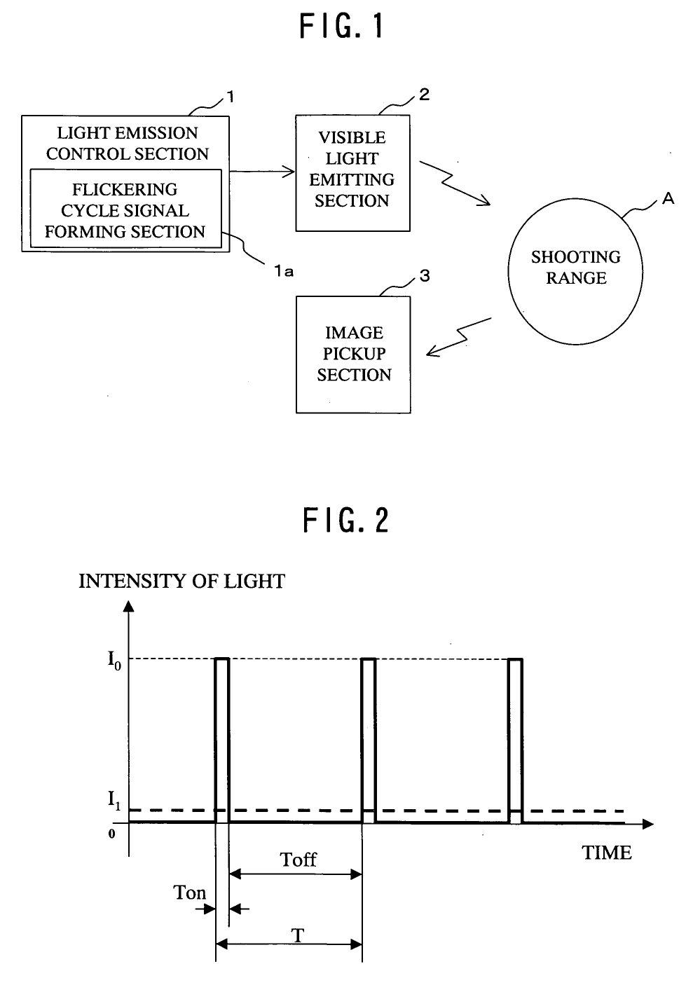

FIG. 1 is a schematic block diagram of the first embodiment of the invention.

The image pickup apparatus of the first embodiment comprises a light emission control section 1, a visible light emitting section 2 that emits visible light to illuminate shooting range A and an image pickup section 3 that shoots the shooting range A.

The light emission control section 1 includes a flickering cycle signal forming section 1a and controls the intensity of light emitted from the visible light emitting section 2 by controlling (raising and lowering) the electric current and so on supplied to the light emitting section so as to make the light emitting section illuminate the shooting range with light of a predetermined intensity at a predetermined cycle (a frequency not lower than the critical fusion frequency) according to the timing chart as shown in FIG. 2.

The visible light emitting section 2 is typically formed by using light emitting diode that emits white light or light emitting diodes that emit light respectively in red, blue and green colors, which are the three primary colors of light so as to emit visible light. The image pickup section (camera) 3 can shoot the range (area) A that is illuminated by the visible light emitting section 2 and pick up an image thereof. The image pickup section 3 may typically be formed by using a CCD camera or a C-MOS camera that is well known and sensitive to visible light. In FIG. 2, the intensity of light when the visible light emitting section 2 is turned on is I₀, the intensity of light when the visible light emitting section 2 is turned off is 0, the lighting on time is Ton, the lighting off time is Toff and the lighting interval is T Man senses the light emitted from the light emitting section as sustained light when T satisfies the requirement of the formula shown below, where CFF represents the critical fusion frequency.
1/T≧CFF

Then, man senses light emitted from the visible light emitting section 2 as light of intensity I₁, which is the time average of the intensities of emitted light.
I₁=Ton·I₀/T

Therefore, the level of I₀ and the duration of Ton are determined by selecting a sufficiently small value for I₁ so that man may not be dazzled by light emitted from the light emitting section and a sufficiently large value for I₀ so that a satisfactorily light image may be picked up by the camera, taking the sensitivity of the camera into consideration.

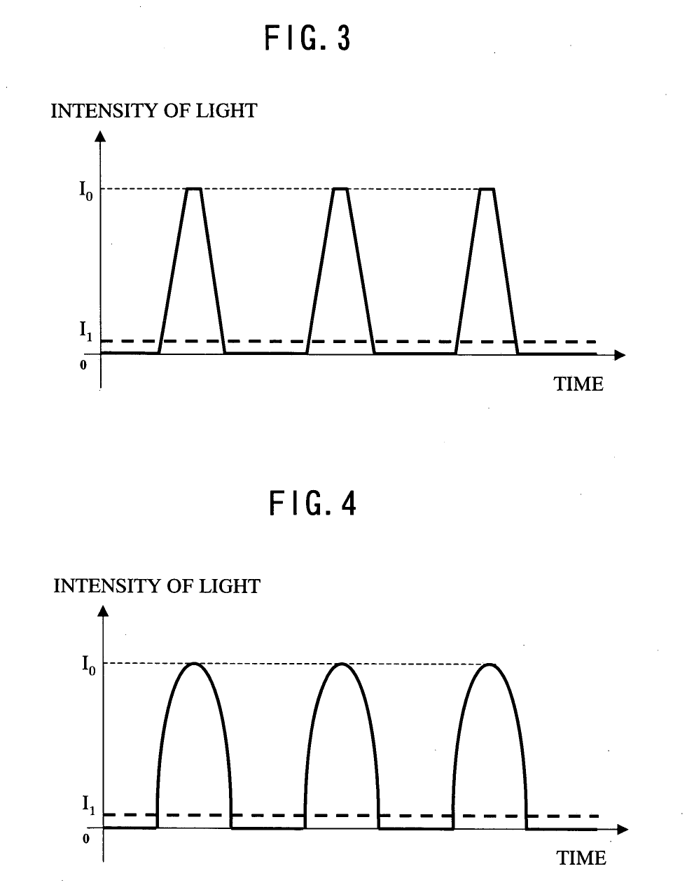

While the intensity of light is changed to show a rectangular waveform, it may alternatively be changed so as to show a trapezoidal waveform as shown in FIG. 3 or a sinusoidal waveform as shown in FIG. 4. In either case, I₁ can be computed as the time average of the intensities of light.

### Second Embodiment

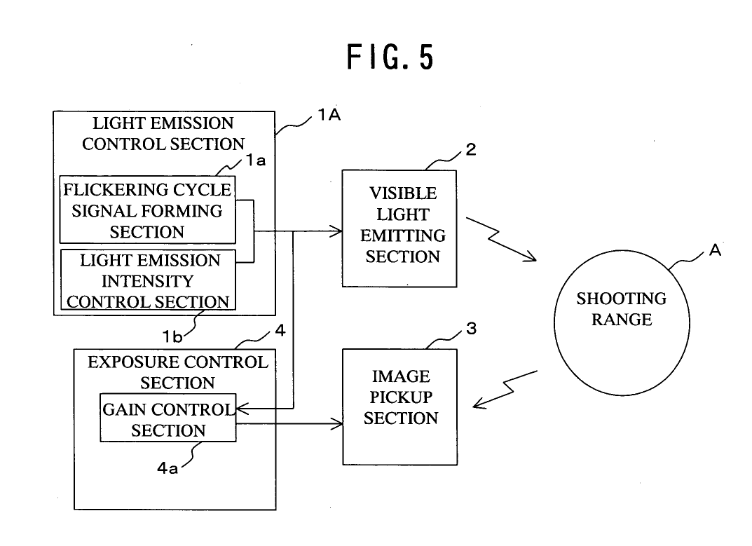

FIG. 5 is a schematic block diagram of the second embodiment of the invention.

In the second embodiment, the light emission control section 1A includes a light emission intensity control section 1b that can variably control the intensity of emitted light (amplitude: lo) and the second embodiment additionally comprises an exposure control section 4 that includes a gain control section 4a.

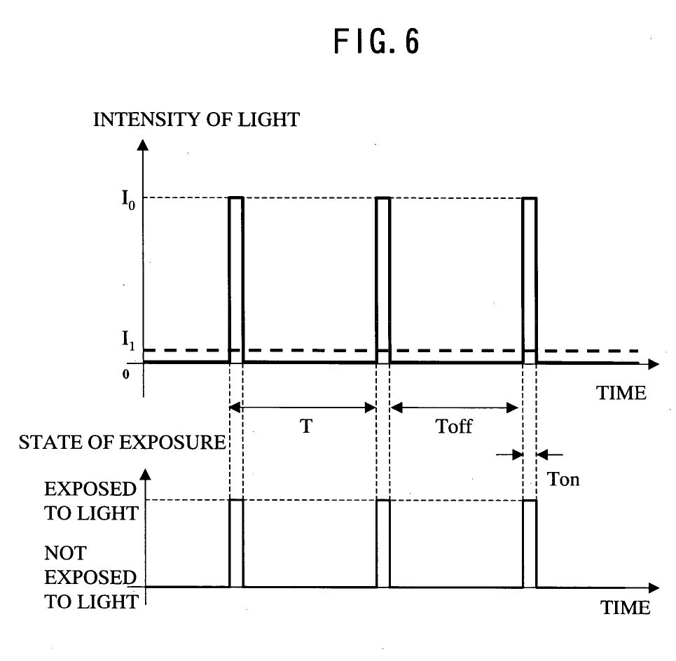

In the second embodiment, the light emission control section 1A controls the intensity of light emitted from the visible light emitting section 2 by controlling the electric current and so on supplied to the visible light emitting section 2 so as to make the visible light emitting section 2 illuminate the shooting range with light of a predetermined intensity at a frequency not lower than the critical fusion frequency according to the timing chart as illustrated in FIG. 6.

The visible light emitting section 2 is formed by using light emitting diode that emits white light or light emitting diodes that emit light respectively in red, blue and green colors, which are the three primary colors of light so as to emit visible light. The exposure control section 4 operates like the light emission control section 1A. In other words, it controls the duration and the timing of exposure to light of the image pickup section 3 according to the timing chart as illustrated in FIG. 6. The exposure to light of the image pickup section 3 is controlled by controlling the gain for exposure of the exposure control section 4 by means of the gain control section 4a. Alternatively, the exposure to light of the image pickup section 3 may be controlled by controlling the duration and the timing of opening the shutter by means of the exposure control section 4. Still alternatively, both the gain and the duration of opening the shutter may be controlled.

The light emission control section 1A operates like its counterpart of the first embodiment so as to satisfy the requirement of the formula described above for the first embodiment, using the intensity of light I₀ when the visible light emitting section 2 is turned on, the intensity of light 0 when the visible light emitting section 2 is turned off, the lighting on time Ton, the lighting off time Toff and the lighting interval T While the intensity of light is changed to show a rectangular waveform as shown in FIG. 6, it may alternatively be changed so as to show a trapezoidal waveform as shown in FIG. 3 or a sinusoidal waveform as shown in FIG. 4. In either case, I₁ can be computed as the time average of the intensities of light.

Because of the operation of the exposure control section 4 illustrated in FIG. 6, the second embodiment can avoid the problem that a light object located in the shooting range is saturated while the remaining objects are too dark in the picked up image because the image shooting section is not exposed to light except the lighting on time due to the fact that the exposure time of the image pickup section 3 is synchronized with the lighting on time. Additionally, the second embodiment can broaden the scope of shooting because the light emission control section 1A includes the light emission intensity control section 1b that can modify the intensity of light (I₀) emitted from the visible light emitting section 2 as a function of the shooting range A. Although not shown, it is possible to arrange a sensor for detecting the illuminance of the shooting range (when light is emitted) to control the gain for exposure and the light emission intensity and realize an optimal shooting operation.

As described above, with any of the above-described embodiments of the present invention, it is possible to pick up a light color image that of an outdoor area that is dark at night without dazzling the person or persons in and near the shooting range.

What is claimed is:

1. An image pickup apparatus for shooting an illuminated range, the apparatus comprising:
a light emitting section that emits visible light to illuminate a shooting range;
a light emission control section that drives the light emitting section to flicker at a predetermined intensity of light and a frequency higher than a predetermined frequency level; and
an image pickup section that shoots the range illuminated by the light emitting section.

2. The apparatus according to claim 1, wherein
the predetermined frequency is the critical fusion frequency.

3. The apparatus according to claim 2, wherein
the time-averaged intensity of light of Ton-lo/T is not higher than a predetermined intensity level, where Ton is the lighting on time of a flickering cycle of the light emitting section, Toff is the lighting off time of a flickering cycle of the light emitting section, T is the lighting interval and lo is the intensity of emitted light.

4. The apparatus according to claim 1, further comprising:
an exposure control section that exposes the image pickup section to light in synchronism with the light emitting time set by the light emission control section.

5. The apparatus according to claim 1, wherein the light emitting section emits white light or light of the three primary colors.

6. An image pickup method for illuminating a shooting range and shooting the range, the method comprising:
emitting visible light so as to flicker at a predetermined intensity of light and a frequency higher than a predetermined frequency level; and
shooting the range illuminated by the visible light.

7. The method according to claim 6, wherein the predetermined frequency is the critical fusion frequency.

8. The method according to claim 7, wherein
the time-averaged intensity of light of Ton-lo/T is not higher than a predetermined intensity level, where Ton is the lighting on time of a flickering cycle of the light emission, Toff is the lighting off time of a flickering cycle of the light emission, T is the lighting interval and lo is the intensity of emitted light.

9. The method according to claim 6, wherein
exposure to light is conducted in synchronism with the time of emission of light.
